(19) United States
(12) Patent Application Publication
(10) Pub. No.: US 2010/0227604 A1
(43) Pub. Date: Sep. 9, 2010

(54) AUTOMATIC LOCAL ACCESS SURROGATE NUMBERS FOR LONG DISTANCE CALLING

(76) Inventor: Cynthia Shu-Yen Hsieh, San Jose, CA (US)

Correspondence Address: Richard Brewster Main, Esq., Patents Pending, 9832 Lois Stiltner Court, Elk Grove, CA, 95624, US

(21) Appl. No.: 12/718,970

(22) Filed: Mar. 6, 2010

Related U.S. Application Data
(60) Provisional application No. 61/158,336, filed on Mar. 6, 2009.

(51) Int. Cl. H04M 3/00

(52) U.S. Cl. 455/418

(57) ABSTRACT

A unique call mapping and routing device combines Voice over Internet protocol (VoIP) and public switched telephone network (PSTN) technologies such that mobile device users are able to dial international calls that are automatically and transparently directed through local access numbers using the mobile carrier PSTN network.

### RELATED APPLICATIONS

This non-provisional patent application claims benefit of U.S. Provisional Patent Application Ser. No. 61/158,336, filed Mar. 6, 2009, and titled INTELLIGENT CALL MAPPING AND ROUTING FOR LOW COST GLOBAL CALLING ON MOBILE DEVICES INCLUDING SMARTPHONE, by Jaewoo Kim, Kyoungsig Kim, and Cynthia Hsieh.

### BACKGROUND OF THE INVENTION

1. Field of the Invention

The present invention relates to mobile phones, and in particular to low-cost global calling from a mobile device.

2. Description of Related Art

Calling cards are a popular way to make discounted long-distance international calls. But using calling cards typically requires the manual entry of long strings of digits that include an access number, a caller account number, and a personal identification number (PIN). Doing that for every call is tedious and puts off many potential customers.

A conventional method of dialing from a mobile phone with a virtual calling card is described by Sean Sealy, et al., in United States Patent Application US 2008/0039074. Here, the destination telephone number is passed to a gateway using dual tone multi-frequency (DTMF) tones. Other conventional methods for global dialing rely on web browsers, or rely on short message service (SMS) to relay local access numbers to a calling party.

### SUMMARY OF THE INVENTION

Briefly, an improved mobile device embodiment of the present invention includes a mobile phone with provisions for downloading and executing application programs, and a wireless device disposed in the mobile phone providing for network access to an applications server, and a telephone call session switch for seamlessly switching communications sessions between PSTN-mode on the mobile phone and VOIP-mode on the wireless device. The improvements are characterized by an application firmware loaded in the mobile phone that causes it to automatically dial a local access number when a long-distance number is entered by a user, and that causes the mobile phone to transmit dual tone multi-frequency (DTMF) tones that encode an authorized subscriber account Identity and said long-distance number entered by said user. A further improvement includes a firmware process loaded in the mobile phone that be used periodically to register the mobile phone with said applications server, and to download local access numbers that can be substituted when a long-distance number is entered by a user. And another improvement includes a mechanism for allowing a second mobile phone to independently make its own long-distance calls automatically through said local-access numbers with access that can be machine validated electronically by causing said second mobile phone to transmit DTMF-tones that encode a copy of said authorized subscriber account identity.

These and other objects and advantages of the present invention will no doubt become obvious to those of ordinary skill in the art after having read the following detailed description of the preferred embodiments which are illustrated in the various drawing figures.

### IN THE DRAWINGS

FIG. 1 is a functional block diagram of a mobile device system embodiment of the present invention in which a special applications software has been installed on a mobile user device; and

FIG. 2 is a functional block diagram of a second mobile device system embodiment of the present invention that requires no special applications software to be installed on a mobile user device.

### DETAILED DESCRIPTION OF THE EMBODIMENTS

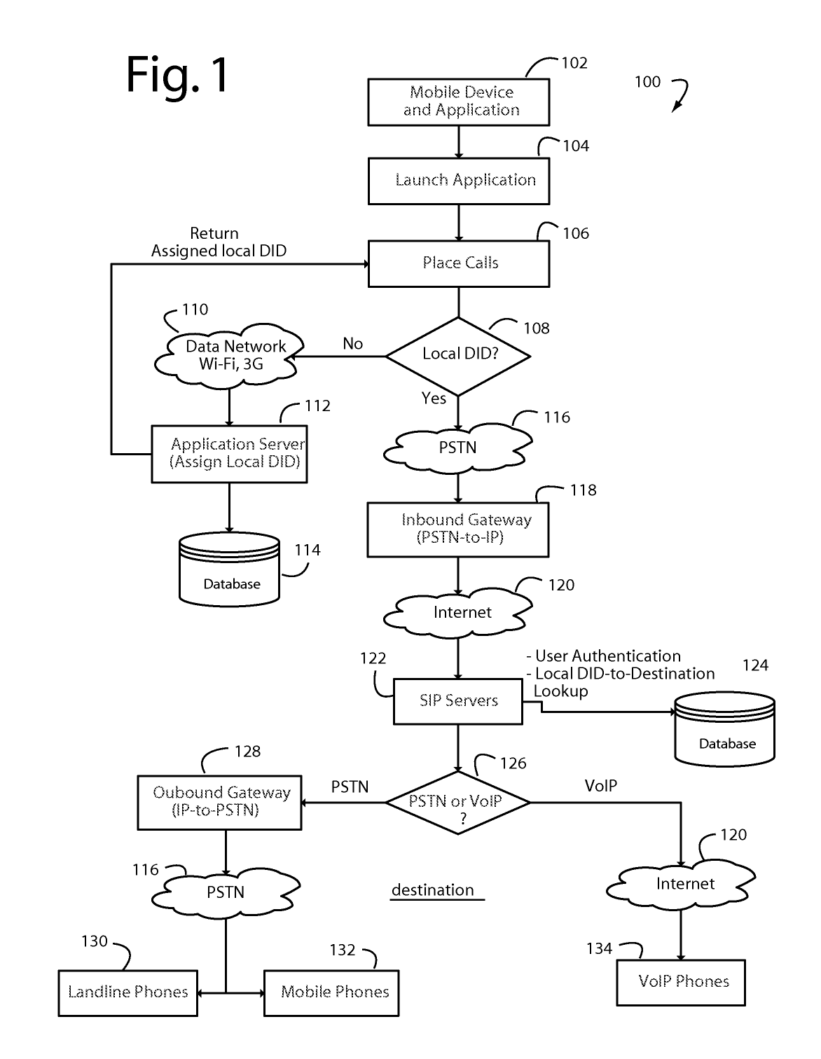

FIG. 1 illustrates a call mapping and routing system 100 according to one embodiment of the present invention. An application firmware is installed on a mobile device 102 that facilitates one call mapping and routing method of the present invention. For example, the application firmware could be in the tangible form of an applet for an iPhone, either on a memory chip or transmitted in an electronic file.

To initiate a call, the application firmware is launched in a process 104. A caller uses the mobile device 102 to place a call in a process 106 by either entering a destination phone number or by selecting a destination phone number from a list of contacts. If a decision process 108 sees the destination phone number is an international number that can be expensive to dial directly, the call mapping and routing system 100 can save the user some expense by accessing a data network 110. An applications server 112 provides a substitute local access number from a database 114. When the caller places the call, the application firmware sends an HTTPS POST request through a Wi-Fi or a mobile data network 110 to the application server 112 112. The application firmware also a caller or subscriber ID and the original destination number that was attempted.

The application server 112 authenticates the caller with their subscriber account ID and telephone caller identification (CID). During registration, each user can associate many different CID's such as home, office, mobile, etc., to the user's subscriber account ID. Once authenticated, the application server 112 extracts the area code from the CID and looks up a corresponding local access number that can be used to carry the international number dialed. It then sends the assigned local access number back to the application firmware 102 for direct inward dialing (DID). The local DID number is typically a number within the same area code of the caller based on their CID or based on GPS coordinates that may be supplied. If no local DID number is available in the same area code, then a DID number from a nearby area code is assigned. The call can then be automatically initiated through the public switched telephone network (PSTN) 116.

A one-to-one mapping of the assigned local DID number associated with dialed international is stored in a mapping table in database 114 and associated with the user's CID. Once an assigned local DID number is returned to the application firmware, e.g., by XML or Web service methods, decision process 108 dials out the assigned local DID number through the mobile carriers AT&T, Verizon, Sprint, T-Mobile, and others on the PSTN 116.

An inbound gateway 118 converts PSTN sessions into IP sessions for the long haul over the Internet 120 to the call destination. When the call placed with the assigned local DID number reaches the inbound gateway 118, SIP, H.323, MEGACO, and other protocols are used to initiate a VoIP call session to a call server 122. The VoIP call setup is used by call server 122 identify and authenticate the user with their CID. The destination number can then be index with the CID from the mapping table in a database 124. The call server 122 replaces the dialed number with the retrieved destination number and sends out a modified Voice over IP call packet to a termination gateway.

In one embodiment, the inbound gateway 118 converts PSTN calls to a Session Initiation Protocol (SIP) call setup message (INVITE) and initiates SIP call sessions to SIP Servers with, (a) the CID: “FROM” tag value with user's mobile number and (b) the destination number: “TO” tag value with the assigned local DID number.

SIP Servers 122 authenticate the caller with the CID in the FROM tag and do a reverse look up to retrieve the actual destination number dialed by the caller based on the assigned local DID number. The retrieved international phone number is put into a “TO” tag. The SIP Servers 122 get the original international number to be dialed and send out INVITE with a “TO” tag value of international number. The SIP Servers 122 look up routing information and determine whether the call is an ON-NET or an OFF-NET call. An ON-NET call is a call within the service subscribers via VoIp phones 134, and an OFF-NET call is a call to a regular landline phone 130 or mobile phone 132.

A decision process 126 sees if the call is an ON-NET call, the SIP Servers 122 send an INVITE directly to a subscriber's SIP device through the Internet. If the call is an OFF-NET call, SIP Servers 122 must send the INVITE to an Internet Telephony Service Provider (ITSP) partner to terminate the PSTN destination. The ITSP converts the SIP call request to a PSTN call setup and finally connects the call to the international party on landline phones 130 or mobile phones 132.

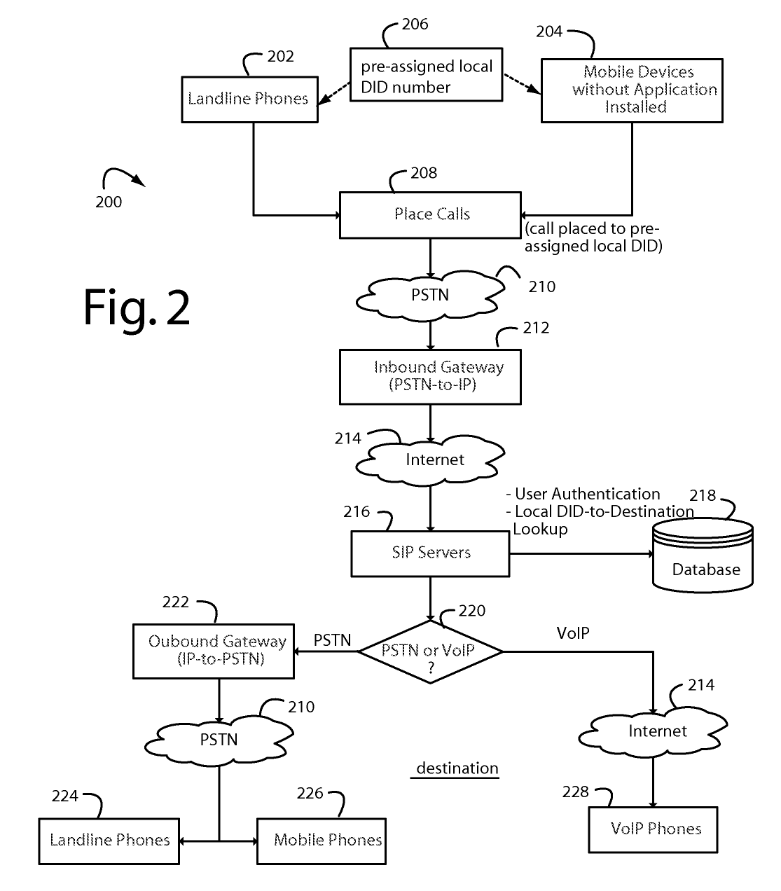

FIG. 2 illustrates a call mapping and routing method 200 in another embodiment of the present invention. In method 200, ordinary landlines 202 and mobiles devices 204 without any special applications firmware each caller makes their calls through a pre-assigned local DID number. No Wi-Fi or mobile data network is required in method 200 to benefit from the call mapping and routing like in FIG. 1.

Each caller is issued an assigned local DID number 206. Each caller can store and associate local DID numbers assigned to destination numbers for future use. Alternately, each caller can access an application server through an Internet webpage where the caller enters a destination phone number and gets back destination phone numbers assigned to corresponding local DID numbers. When a caller launches an application firmware on a mobile device, any stored phone numbers and assigned local DID numbers are downloaded to the mobile device.

Once downloaded, each caller can autonomously place calls on their contact lists with a process 208 without requiring the support of a Wi-Fi or a mobile data network. Callers launch the application firmware and dial an assigned local DID number. The application firmware dials out the assigned local DID number through PSTN 210. The call reaches an inbound gateway 212 for PSTN-to-IP conversion. The gateway converts PSTN calls received into a Session Initiation Protocol (SIP) call setup message (INVITE), and initiates a VoIP call session over Internet 214 to SIP Servers 216.

The gateway 212 sends the SIP Servers, (a) the CID: “FROM” tag value with user's mobile number; and (b) the destination number: “TO” tag value with the assigned local DID number. The SIP Servers 216 authenticate the caller with the CID in the FROM tag and do a reverse look up to retrieve the actual destination number dialed by the caller based on the assigned local DID number. The retrieved international phone number is put in the “TO” tag. The SIP Servers finally obtained the original international number to be dialed and send out INVITE with a “TO” tag value of international number.

The SIP Servers look up routing information in a database 218 and determine whether the call is ON-NET or OFF-NET call. ON-NET calls are within the service subscribers, and OFF-NET calls are to regular landline or mobile phones.

If the call is an ON-NET call, the SIP Servers directly send INVITE to the subscriber's VoIP device through Internet.

If the call is an OFF-NET call, SIP Servers send INVITE to ITSP partners to terminate the PSTN destination. The ITSP converts the SIP call request to a PSTN call setup and finally connects the call to the international party.

Such call mapping and routing can be implemented with a Wi-Fi, a 3G, EDGE, GPRS, or other mobile data network such that mobile device users still can make low cost international calls even when there is no Wi-Fi or mobile data network availability. Access to a data network is needed only for initial user registration and user authentication prior to placing the call. The call mapping and routing system and method of the present invention can integrate with the mobile device's pre-existing contact directory or phonebook for ease of use. Alternately, the call mapping and routing can operate standalone and independent of a mobile device's pre-existing contact directory or phonebook.

The present invention provides a low-cost international calling alternative to high-cost mobile wireless services by providing a system, method, and application on the mobile devices that automates user authentication, billing, routing, and connection to international parties. In this manner, the call mapping and routing system and method of the present invention realizes a simple, easy-to-use, and cost-effective international calling system for mobile device users.

Here, mobile devices include cell phones, call-enabled personal data assistants, smartphones such as the iPhone manufactured by Apple Inc. (Cupertino, Calif.), Palm Devices by Palm Inc. (Sunnyvale, Calif.), Android G1-like Devices by Google Inc. (Mountain View, Calif.), Blackberry Devices by Research In Motion (Ontario, Canada), etc.

In one embodiment, a mobile device user places a local call to connect to international parties so only local call charges apply. When the mobile device user dials an international number, the call mapping and routing automatically maps the international number dialed to a local, direct inward dial (DID) number.

In another embodiment, international number to local DID number mapping is processed using an application server 112 being part of the call mapping and routing system of the present invention. The mobile device needs to have a Wi-Fi or mobile data network available to carry out the mapping function. In another embodiment of the present invention, a mobile device user may store a local DID number mapped to an international number so that subsequent dialing of the international number is carried out using the stored local DID number and dose not require further mapping, thus eliminating the need for a Wi-Fi or data network.

In other words, when Wi-Fi or mobile data network is present, a mobile device user can place an international call by directly dialing international number. When there is no Wi-Fi or mobile data network, the mobile device user can still make the international call by dialing a pre-assigned local DID number. The application server 112 stores a block of local DID numbers which are shared among all of the users of the call mapping and routing system. The application server 112 associate the local DID number with the CID of the user so that each local DID number is unique to each user by virtue of the CID of the user. In the case when there is no local DID number available for a specific geographic area, the closest neighbor DID number is assigned. In another embodiment, the call mapping and routing system and method of the present invention also uses the GPS coordinates of GPS-enabled mobile devices to assign the local DID number based on the present location where the call is placed. In one embodiment, the call mapping and routing system and method allows a mobile device user to store the mapped local DID number to the contact directory in the mobile device. Once stored in the contact directory, the application server 112 permanently assigns the mapped local DID number to the specific international number for the CID of the user. Accordingly, a mobile device user can call the same international number by directly dialing the local DID number or by selecting the contact from the contact directory. By storing the assigned local DID number, the mobile device user can make an international call without using Wi-Fi or mobile data network.

According to another aspect of the present invention, the call mapping and routing system and method of the present invention allows multiple telecommunication devices, such as landline telephones or other mobile devices, to use a single user account and to access the same phone number list. In this manner, multiple telecommunication devices share the same local DID number to reach the same destination. For instance, a user accesses the call mapping and routing system and method of the present invention through a webpage and set up a list of contacts with pre-assigned local DID number mapped to destination telephone numbers. The user also identifies the authorized CID that can access the account. Another user may use a landline telephone to dial the pre-assigned local DID number. The application server 112 authenticates the landline CID and dials the destination phone number associated with the local DID number.

Embodiments of the present invention include cloud or virtualization VoIP calling. In desktop virtualization and cloud computing environments, users can lease a computing or desktop environment from a cloud service provider, e.g., Amazon Elastic Compute Cloud (E2C) from any location with internet access. Users can also lease phones or check out an office phone extension from any location with full office PBX capability. When the cloud persona or identity has been verified, the leased extension can be mapped to mobile devices so they can piggy back with the local number to make long-distance calls. The routing and mapping methods of the present invention can be thereafter used to make international and long distance calls from any location.

A corporate IT department can pre-map or populate the contact directory of their mobile phones for all corporate issued non-domestic mobile devices. So when a coworker in Japan is called, e.g., a local number is dialed automatically that has a very inexpensive call rate.

An improved mobile device is therefore realizable that has a mobile phone with provisions for downloading and executing application programs, and a wireless device disposed in the mobile phone providing for network access to an applications server, and a telephone call session switch for seamlessly switching communications sessions between PSTN-mode on the mobile phone and VOIP-mode on the wireless device.

The improvements are characterized by an application firmware loaded in the mobile phone that causes it to automatically dial a local access number when a long-distance number is entered by a user, and that causes the mobile phone to transmit DTMF-tones that encode an authorized subscriber account Identity and said long-distance number entered by said user. A further improvement includes a firmware process loaded in the mobile phone that be used periodically to register the mobile phone with said applications server, and to download local access numbers that can be substituted when a long-distance number is entered by a user. And another improvement includes a mechanism for allowing a second mobile phone to independently make its own long-distance calls automatically through said local-access numbers with access that can be machine validated electronically by causing said second mobile phone to transmit DTMF-tones that encode a copy of said authorized subscriber account identity.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the scope of the invention.

1. An improved mobile device, comprising:
a mobile phone with provisions for downloading and executing application programs;
a wireless device disposed in the mobile phone and for providing network access to an applications server; and
a telephone call session switch for seamlessly switching communications sessions between PSTN-mode on the mobile phone and VOIP-mode on the wireless device;
characterized by:
an application firmware loaded in the mobile phone that causes it to automatically dial a local access number when a long-distance number is entered by a user, and that causes the mobile phone to transmit DTMF-tones that encode an authorized subscriber account identity and said long-distance number entered by said user.

2. The improved mobile device of claim 1, further comprising:
a firmware process loaded in the mobile phone that be used periodically to register the mobile phone with said applications server, and to download local access numbers that can be substituted when a long-distance number is entered by a user.

3. The improved mobile device of claim 1, further comprising:
a mechanism for allowing a second mobile phone to independently make its own long-distance calls automatically through said local-access numbers with access that can be machine validated electronically by causing said second mobile phone to transmit DTMF-tones that encode a copy of said authorized subscriber account identity.
